(19) United States
(12) Patent Application Publication
(10) Pub. No.: US 2026/0349430 A1
(43) Pub. Date: Nov. 5, 2026

(54) METHOD FOR PRODUCING A SURVEY OF A PLOT OF VEGETATION ROWS, SYSTEM AND METHOD FOR GUIDING AN AUTONOMOUS MACHINE BASED ON A SURVEY

(71) Applicant: EXEL INDUSTRIES, EPERNAY (FR)

(72) Inventor: Alex SCHULSTER, EPERNAY (FR)

(73) Assignee: EXEL INDUSTRIES, EPERNAY (FR)

(21) Appl. No.: 19/660,793

(22) Filed: Apr. 28, 2026

(30) Foreign Application Priority Data
Apr. 30, 2025 (FR) 2504622

(51) Int. Cl. G05D 1/246; G05D 1/229; G05D 1/248; G05D 1/622; G05D 105/80; G05D 107/20; G05D 109/10; G05D 111/10

(52) U.S. Cl. CPC G05D 1/246; G05D 1/229; G05D 1/248; G05D 1/622; G05D 2105/87; G05D 2107/21; G05D 2109/10; G05D 2111/17

(57) ABSTRACT

A system and method for producing a fine survey of a plot of vegetation rows (VG) that include: A- acquiring a preliminary survey (ARP1) that includes designating map points from cartographic data, and deducing initial survey data for guidance purposes, B- a travel step, wherein, on the basis of the initial survey data, the rows of the plot are traversed by an autonomous machine equipped with a geolocation sensor and a row detection sensor making it possible to determine an actual location of a row relative to the machine, a refined waypoint position being constructed by projecting the current geo-position of the geolocation sensor (PRB) onto the row centerline, and C- determining, from the refined waypoints second survey data forming a fine survey (ARP2) for precision work purposes.

### CROSS-REFERENCE TO RELATED APPLICATION

This regular U.S. utility application claims the benefit of France 2504622 filed on Apr. 30, 2025, the contents of which are expressly incorporated herein by reference.

### TECHNICAL FIELD

The present invention relates to the field of autonomous agricultural machines that can carry out certain work in plots of vegetation rows based on a prior survey. “Plot” is understood here as a land parcel, especially an agricultural land parcel.

“Survey” is understood here as a set of information making it possible to know the position of the rows of vines (or, more generally, rows of vegetation) in a geolocation system. Thus, a survey of a plot of vegetation rows may contain geolocated positions of a row start point and a row end point for each row, with waypoints, where applicable, in particular where the row is not straight, without excluding the inclusion of the position of each foot (e.g. vine trunk) or each plant.

Obtaining such a survey makes it possible for an autonomous machine of the robotized agricultural-machine type to carry out various viticultural, arboreal or agricultural tasks, in particular in order to be able to carry out work in the plot without permanent assistance from a human operator.

A survey with high good accuracy makes it possible to consider carrying out precise work, in particular at the base of the vegetation rows, such as weeding in the vicinity of the vine stocks.

Automation of certain tasks in orchards and vineyards is increasing sought; hence the interest in having a survey available for each plot of rows of vines or rows of shrubs/trees.

The agricultural machines targeted are robotized machines with autonomous guidance, in viticulture in particular, such as a vineyard straddle carrier. The invention can also be implemented in the context of using other types of autonomously guided agricultural machines. The robotized machines may be carried on wheels, without excluding the case of tracks.

### State of the Art

A known surveying practice is to carry out a topographic survey with geolocation of the positions of the end of rows using a GPS receiver mounted on a pole that an operator places successively at the locations to be recorded, validating the point and proceeding, step by step, to cover all the rows of the plot. In addition, if the row is curved, it is also necessary to record intermediate points on the path of the row.

This method proves to be long and tedious for medium-size plots and even more so for large plots.

Moreover, solutions have been proposed for making an autonomous tractor move in an orchard, in particular in circumstances where the GPS signals are masked by the presence of foliage at height, as, for example, according to documents WO2024135018, US2020029488 or US2024241518.

As a result, there remains a need to obtain a precise survey more quickly and at lower cost. In this context, the present inventors have proposed the method that will now be presented.

### SUMMARY

In this context, the present invention relates to a method for producing a fine survey of a plot planted with a plurality of vegetation rows (e.g. in a vineyard, an orchard or other), the method comprising:
A- a step of acquiring a preliminary survey from a digital device, comprising designating map points from cartographic data (such as by means of access to a cartographic database), and directly or indirectly deducing initial survey data, for guidance purposes, the initial survey data comprising, for each row, a first position (21a) relative to a first end of a row (PE1), and a second position (21b) relative to a second end of a row (PE2),
B- a travel step, wherein, all the rows of the plot are traversed on the basis of the initial survey data by an autonomous machine, preferably a straddle machine, equipped with a geolocation sensor (GPS/GNSS) forming part of a centimeter-accuracy geolocation system, with at least one row detection sensor enabling an actual location of a row centerline (LC) to be determined relative to the machine, the geolocation sensor preferably being arranged on a longitudinal median plane of the autonomous machine, the travel step comprising, iteratively:
   recording a current geo-position of the geolocation sensor (5), and simultaneously determining a position of the centerline (LC) relative to the machine and relative to its geolocation sensor,
   determining a current projected geolocated position (PCJ) on the centerline (LC) of the row, in order to deduce refined and geolocated waypoints of the path of the row,
C- determining a set of new survey points from the refined waypoints, to output second survey data that forms a fine survey of the plot for precision work purposes, the second survey data comprising at least a first refined position of the first end of a row and a second refined position of the second end of a row, for each row.

By means of this arrangement, by using an autonomously guided machine and a preliminary surveying step, carried out very quickly on a computer/digital device (such as a computer or smartphone), and then using the path and recording of the actual positions (as will be seen in detail later), a precise survey of the plot is advantageously obtained, with all the rows effectively present in the plot and, optionally, where applicable, the U-turn areas at the ends of rows.

In practice, the initial survey data is part of a first survey file and the second survey data is part of a second survey file.

The current projected geolocated position is constructed by projecting the current geo-position of the geolocation sensor (PRB) onto the centerline (LC) of the row, either by taking the closest point on the centerline (LC) or by projecting the current geo-position (PRB) perpendicularly to the local direction of the row centerline (LC) and toward the centerline (LC).

Incidentally, the method provides for determining a lateral offset (∆L) of the geo-position of the geolocation sensor (5) relative to the centerline (LC) of the row. The lateral offset (∆L) is preferably considered along the transverse direction Y of the machine.

It should be noted that the lateral offset (∆L) between the geo-position of the geolocation sensor and the centerline (LC) of the row generally remains small, typically a few centimeters or a few tens of centimeters. If the trajectory of the machine were perfect relative to the row (a theoretical, not realistic case), this lateral offset (∆L) would be zero (for a sensor in a median plane of the machine, i.e. above the row).

It should also be noted that the preliminary cartographic survey data is sufficient to feed the guidance function of the autonomous machine, even if not very accurate, with the guidance function then being able to realign in real time during passage relative to the actual position of each row captured by the row detection sensor. During the travel step (B-), the continuous use of the geolocation system, accurate to the centimeter, is advantageously made use of. Note that in the case of a straddle machine, which straddles and overhangs the vegetation row, receipt of the geolocation signals is hindered by no foliage or other obstacle (with satellite visibility guaranteed without interposition of obstacles).

In other words, to rephrase the inventive step of the present invention, the initial survey data (which is not necessarily highly accurate) helps the guidance function of the autonomous machine so that it can traverse all the rows successively, one by one. Then, during the travel step, the sensors available on the autonomous machine make it possible to carry out an on-site recording of the actual geolocated positions, which makes it possible to establish the second survey data that forms the fine survey of the plot.

As will be discussed later, the row detection sensor may take several forms; it may be a lidar sensor, for example, but it may also be an imaging device, without excluding ultrasound sensor technologies or using a sensor by physical contact. The row detection sensor may detect the row directly by the contours of its vegetation or by its footprint on the ground (plants, trunks, trellis stakes, etc.).

It should be noted that the (first and/or second) survey data for each row comprises a first position relative to a first end of the row, and a second position relative to a second end of the row. In addition, the first and/or second survey data most often also comprises intermediate crossing points (“waypoints”). Moreover, the survey data for the plot may also include the boundary of a limiting work area that encompasses at least the plurality of rows and the areas available for making turns at the end of a rows.

In certain advantageous cases, the initial survey data is deduced indirectly from the map points resulting from the designation of points, after optional consideration of a known realignment, based on correction data obtained from a prior fine survey of a neighboring plot.

In other standard cases, the initial survey data is deduced directly from the map points resulting from the designation of points, without any particular realignment.

It should also be noted that the row centerline is determined from the row detection sensor(s), and, in reality, the trajectory of the center of the autonomous machine will not coincide precisely with the centerline of the row all the time due to the wheels of the machine rolling over irregularities of the ground surface, or due to small slipping movements of the wheels on the ground.

Thus, there is a lateral offset in practice between the position of the geolocation sensor and the centerline of the row, and the trajectory control loop constantly strives to reduce the observed offset in order to follow the row centerline determined by the data returned from the row detection sensor(s) as well as possible. This lateral offset can also be managed by taking into account an offset of the position of the geolocation sensor if the latter is not located in a median plane of the machine.

In the particular case of a straddle machine, the GNSS geolocation receiver may be located at the center, i.e. on a longitudinal median plane of the machine and, in practice, it may generally be located above the row centerline; the mean lateral offset is then zero due to the tracking of rows by the row detection sensor(s).

According to one aspect of the proposed method, determining the fine survey consists in adopting the new points obtained from the geolocated positions projected onto the row centerline, having forgotten the survey points contained in the initial survey data. A parallel process nonetheless makes it possible to record the differences between the observed geolocated positions and the corresponding positions known from the initial survey data in order to benefit the subsequent surveying methods of neighboring plots. In other words, the second survey file replaces the first survey file.

According to one embodiment, the respective first and second survey data, for each row, comprises a first position relative to a first end of a row, a second position relative to a second end of a row and, optionally, one or more waypoints PPi (with i denoting an index here) at intermediate positions on the path of the row between the first end and the second end.

In configurations where the rows are straight, the survey data may be simplified for each row and contain only the two end points. In configurations where the rows are not straight, as, for example, the one illustrated in FIG. 10, it is then necessary to supplement the aforementioned survey data for each row with one or more waypoint(s). The guidance can then use interpolation based on said waypoints to construct the row centerline from the end points and the waypoints. The interpolation in question may be linear interpolation or polynomial interpolation.

Moreover, the first position may be offset from the physical position of the start of vegetation (e.g. first vine stock) due to the presence of a trellis guy wire. Of course, the same applies to the second position, which may likewise be similarly offset. This makes it possible to secure the turning maneuvers of the autonomous machine. Incidentally, this makes it possible to secure the turning maneuvers of other autonomous machines that may be made to work on the same plot, with the same second survey data (the fine survey).

According to one embodiment, the first and second survey data comprise a delimitation of a work area that encompasses the plurality of rows and defines an external boundary of movement for the autonomous machine.

This delimited work area makes it possible to prevent the autonomous machine from tipping into a bordering ditch or contacting an obstacle (tree, post, etc.), for example. This delimited work area also makes it possible to prevent surveying the neighboring plot by mistake.

It is noted that this work area comprises a sufficient area at the ends of rows for the autonomous machine to make U-turns, making it possible for it to reach a next row from a previous row in its path. Of course, the rows are traversed in a back-and-forth mode, i.e. without “empty” return.

According to one embodiment, during the travel step by the autonomous machine, one or more restrictions and/or modifications of the work area are defined, as applicable, delimiting an external boundary of movement for the autonomous machine, in response to an obstacle detection, for example.

Thereby, the work area can be readjusted based on actual conditions.

According to one embodiment, the method may further comprise a comparison, for each survey point of the initial survey data, of the position acquired in real time, relative to an estimated position obtained from the initial survey data.

In practice, the difference obtained makes it possible to establish correction data in order to be able to provide a correction for future surveys of neighboring plots.

An average of the corrections of the initial guidance data comprising the row end points, waypoints and turning areas may be used. This average of the corrections corresponds to a general offset that affects all positions.

According to one embodiment, two consecutively traversed rows are not physically adjacent during the travel step by the autonomous machine.

In practice, there is at least one row between two consecutively traversed rows; in other words, the U-turn “skips” at least one row, as illustrated in FIG. 11.

According to another aspect of the invention, it also relates to a system for producing a fine survey of a plot of vegetation rows, comprising:
a digital device for access to a cartographic database, in particular satellite photos, including a computer or a multifunction smart phone (i.e. a smartphone), for example, with a preliminary survey being able to be carried out offline from said digital device,
an autonomous machine, preferably a straddle machine, equipped with a geolocation sensor (GPS/GNSS) forming part of a geolocation system with accuracy to the centimeter, and with at least one row detection sensor, the autonomous machine comprising at least one control unit (coupled to a remote server or to a remote or nomadic device, for example), configured:
   to acquire first guidance data resulting from a prior step of acquiring a preliminary survey (ARP1) from the digital device (9) for access to a cartographic database, the initial survey data comprising, for each row, a first position (21a) relative to a first end of a row (PE1), a second position (21b) relative to a second end of a row (PE2),
   by traversing all the rows of the plot (99), to collect second survey data resulting from determining a row centerline from the row detection sensor(s) and from simultaneously determining the current geo-position of the geolocation sensor of the machine (PRB), the control unit being configured to establish the second survey data that forms a fine survey, the second survey data comprising at least a first refined position of the first end of a row and a second refined position of the second end of a row, for each row.

The second survey data is derived from refined waypoints, which themselves are obtained by projection onto the centerline of the successive geo-positions of the geolocation sensor.

Using the information delivered by the row detection sensor(s), the control unit can determine a lateral offset of the current position of the machine relative to a row centerline. From this, the control unit constructs a current projected geolocated position on the row centerline, in order to deduce a so-called “refined” waypoint of the path of the row. From the refined waypoints, the second survey data is obtained.

According to one embodiment, the autonomous machine is a self-propelled straddle machine. This type of machine is very useful for viticultural work.

According to one embodiment, the autonomous machine has a longitudinal median plane (PML) and the geolocation sensor (5) is located in the longitudinal median plane (PML) of the machine. There is no lateral offset to manage; the geolocation sensor is “naturally” located exactly above the vegetation row. The case of lateral tilt induced by a side slope will be discussed at the end of the description.

According to one embodiment, the at least one row detection sensor comprises a Lidar sensor. This type of sensor is becoming increasingly affordable and offers very significant performance for shape recognition, whatever the ambient lighting level. For the record, a lidar (laser remote sensing) is a term now commonly used and derived from “Light Detection and Ranging”.

According to one embodiment, the geolocation sensor is configured to receive signals from one or more satellite constellations comprising the GPS, Glonass, Galileo constellations and other similar system(s).

According to one embodiment, the system uses an improved-accuracy geolocation system by using coordinate corrections known as GNSS DRTK. Accuracy to the centimeter is obtained thereby for the fine survey. The term “RTK” is explained further on.

According to one embodiment, the control unit is coupled via a wireless link with a server or remote device managing survey data, and is wirelessly connected to a data server for RTK geolocation correction.

According to one embodiment, the autonomous machine may be equipped with different tools: clod-breaking discs, spraying system, inter-vine hoeing system. A wide variety of tasks can be carried out using the fine survey obtained by the method promoted here.

### BRIEF DESCRIPTION OF THE DRAWING FIGURES

The invention will be better understood upon reading the description that follows, given solely by way of example and referring to the appended drawings, given by way of non-limiting examples, wherein identical references are given to similar objects and wherein:

FIG. 1 shows an example of a plot of rows of vines, such as a satellite snapshot extracted from a cartography software;

FIG. 2 shows the plot represented in FIG. 1 in semi-transparency, wherein the rows are represented together with a preliminary survey record produced using a computer mouse or by pointing points on a touch screen;

FIG. 3 shows a survey portion in more detail, with crosses at the ends of rows corresponding to the preliminary survey points resulting from mouse clicks or touch-screen pointing, and circles representing the actual geolocated positions of the ends of rows recorded by the autonomous machine as it traverses them;

FIG. 4 shows an example of equipment used to carry out the preliminary survey offline;

FIG. 5 represents a block diagram of the elements involved in an autonomous machine for guidance and trajectory tracking;

FIG. 6 illustrates a top view of an example of an autonomous machine used to implement the method promoted here;

FIG. 7 illustrates a front view of an example of an autonomous machine used to implement the method promoted here;

FIG. 8 illustrates a side view of an example of an autonomous machine used to implement the method promoted here;

FIG. 9 shows an example of actual trajectory tracking with lateral offset and steering control about the target trajectory line;

FIG. 10 shows a surveying diagram in the case of a curved, non-straight vegetation row;

FIG. 11 shows a diagram of an example of a path of the autonomous machine in the vegetation-row plot;

FIG. 12 shows an example flowchart illustrating the method according to the present invention.

It should be noted that the figures set out the invention in detail to make it possible to implement the invention; although non-limiting, these figures serve to better define the invention in particular, as applicable.

### DETAILED DESCRIPTION

The invention relates to methods for producing surveys of vineyard plots or orchard plots (more generally plots comprising vegetation rows) with a view to enabling autonomously guided machines to work on these plots.

The invention makes use of an agricultural machine 2. The features of the invention are presented below in the particular case of a straddle-type tractor.

The agricultural machine is an autonomously guided machine. The agricultural machine is equipped with four wheels W, but other configurations are not excluded. The agricultural machine is equipped with a geolocation sensor 5 (referred to in the trade as GPS or GNSS) and at least one row detection sensor 7. The characteristics and functions of these sensors will be discussed later.

As regards spatial reference, direction X corresponds to the longitudinal direction of the machine, e.g. its normal direction of travel, direction Z corresponds to the vertical direction and direction Y, perpendicular to the previous two, corresponds to the transverse direction of the machine.

In the illustrated example, the autonomous machine 2 is equipped with a system for spraying a product in liquid form, the product being intended to be projected as droplets onto a target vegetation VG such as shrub foliage or vineyard foliage. However, the autonomous machine could be intended to carry out other work such as ground weeding, leaf removal, etc.

The straddle tractor comprises a structural chassis, generally of rectangular shape when viewed in a horizontal plane. The length along the longitudinal axis X is substantially greater than the width along the transverse axis Y, because the overall width L1 of the straddle tractor must remain limited, as already mentioned in the introductory part.

The straddle tractor passes above the vegetation of the target vegetation row VG. As illustrated in FIG. 7, this ground clearance H1 is at least 1 meter; it may be between 1 m and 1.5 m in practice. The overall width L1 may be between 1.2 m and 1.6 m.

The chassis carries at least one motorization unit, a hydraulic unit and/or a pneumatic unit and various control systems, some of which will be discussed in detail later. The motorization unit may be electric, with a battery and an electric machine.

### Preliminary Survey

According to the proposed method, a first surveying step is carried out using computer means in an offline mode, that is, in a place independent of the location of the target plot.

As illustrated in FIG. 4, this preliminary surveying step, denoted A-, can be performed on a computing station such as a laptop computer 9 that has connectivity to the internet network. In other embodiments this preliminary surveying step may be performed on a multifunction phone, commonly called a “smartphone”.

Performing this preliminary surveying step in offline mode, using aerial maps downloaded beforehand, is not excluded.

The target plot for which a precise survey is to be produced is chosen; FIG. 1 illustrates such a plot 99. Here, in the illustrated example, there are about sixty rows 1 that are straight and parallel to one another. It is noted that the lengths differ, however, in particular at the plot edges.

The preliminary surveying method consists in pointing (also called designating) each of the two ends of each row while recording the geolocated coordinates.

A geolocated coordinate should be understood as a position in latitude and longitude, for example, expressed in degrees, minutes and seconds of arc as it is known in geolocation systems. An expression in decimal degrees is also possible.

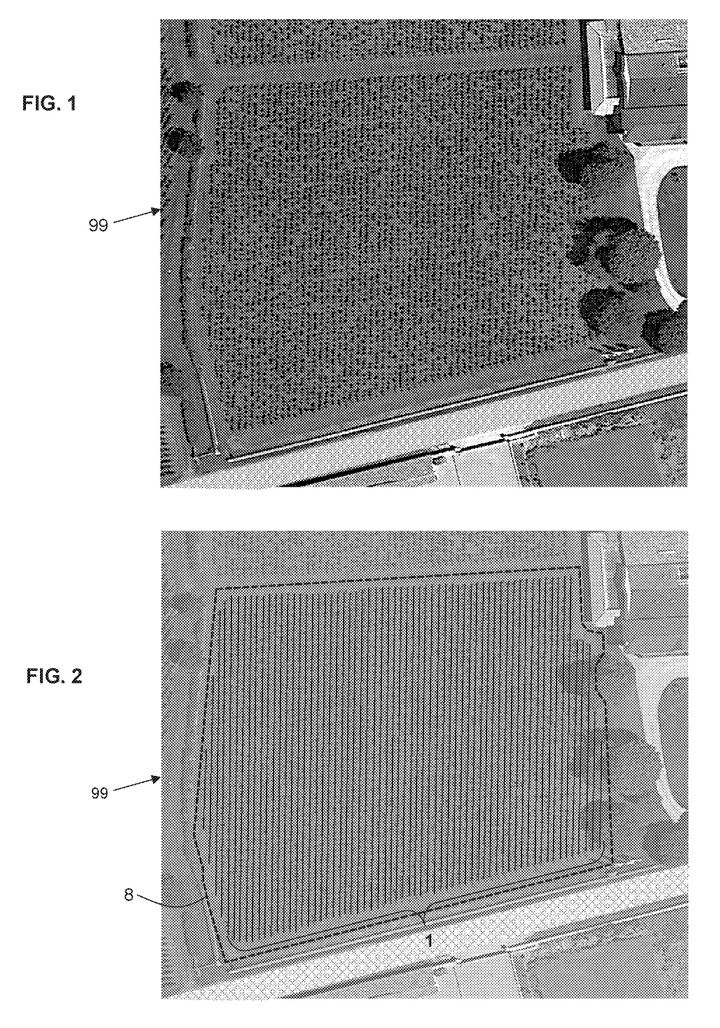

An application such as Google Maps™, Mappy™ or Geoportal™ may be used, without excluding other similar applications that make cartographic data available (“Carto data” in FIG. 4). In practice, satellite snapshots are used, using which the rows 1 are visible, as illustrated in FIGS. 1 and 2.

As illustrated in FIG. 2, each row of a set of rows, referenced 1, has been materialized, as well as a work area, referenced 8.

In the case where the rows are straight, it suffices to point the first end and the second end of a given row with the computer mouse, so as to record the preliminary survey for the row considered. If the row in question is not perfectly straight and slightly curved, recording the two end positions also suffices in the proposed method, because, as will be seen, the guidance system of the autonomous machine in the actual field has the function of following the path of the actual row, even if the row is not straight and has some curved.

On the other hand, if the row has a pronounced curve, then it is useful to point intermediate positions, to facilitate subsequent guidance of the autonomous machine.

In reality, the designation (or pointing) with the mouse 91 may be subject to accuracy issues, either on the part of the operator, or due to insufficient screen definition 90, or due to imperfection(s) in aligning the satellite snapshot relative to the actual location of the pointed positions.

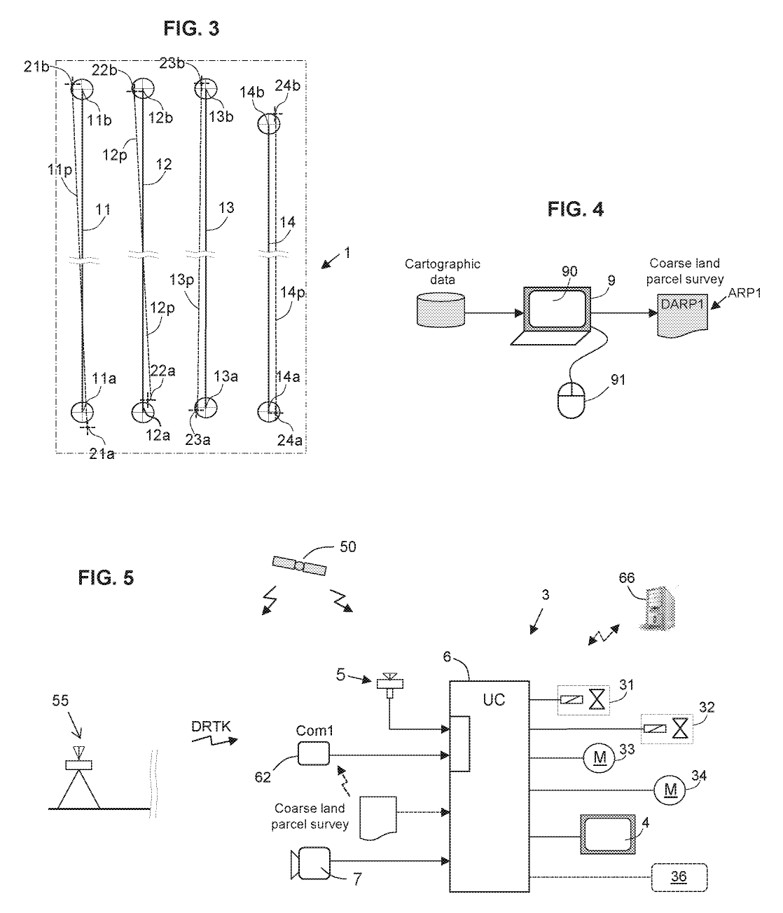

FIG. 3 illustrates only four exaggeratedly small rows, for conciseness and clarity of presentation; it can be seen that the positions pointed by the mouse 91 are represented by simple crosses and do not coincide perfectly with the actual positions of the ends of rows, which are represented by circles with crosses.

Thus, the preliminary survey yields a segment 11p for the first illustrated row, extending from the first pointed position 21a to the second pointed position 21b. Likewise, another segment 12p extends from the first pointed position 22a to the second pointed position 22b, another segment 13p extends from the first pointed position 23a to the second pointed position 23b and yet another segment 14p extends from the first pointed position 24a to the second pointed position 24b.

FIG. 3 also shows the refined end positions (11a,11b) for the first row 11, the refined end positions (12a,12b) for the second row 12, the refined end positions (13a,13b) for the third row 13, and the refined end positions (14a,14b) for the fourth row 14. The refined end positions are determined after actual path in the plot, as will be discussed later.

The set of refined end positions, and optionally of refined waypoints, form a set of new survey points, to obtain the second survey data that forms a fine survey (ARP2) as output.

Returning to the preliminary survey, the delimited work area referenced 8 is also determined by pointing a certain number of points that contribute to the contour of the work area; this contour forms a closed line. The internal area of this closed line serves as a work area, and the outside is where the autonomous machine is not authorized to move.

It should be noted that it is possible to have exclusion areas within the main area; the work area then contains forbidden sub-areas (such as the pylon or electric pole, a tree, a pond, etc.).

In summary, the designation of the map points forms the initial survey data DARP1 for purposes of subsequent guidance of the autonomous machine.

According to one particular optional example, the initial survey data is corrected using knowledge of prior survey results for neighboring plots. In this case, a general shift is applied to the coordinates obtained, which forms a realignment and, consequently, the initial survey data is then deduced indirectly from the designation of points on the map via the computing tool 9.

It is thus possible to take advantage of previous surveys, to have the preliminary surveying step of the plot of interest benefit from recalibration that aids in guiding the autonomous vehicle. This is shown by the feedback loop BR illustrated in FIG. 12.

The result of the preliminary surveying method takes the form of a digital file ARP1 that mainly contains the geolocated data DARP1, but also the contextual data of this operation, namely the source of cartographic data used, the date and time of carrying out the preliminary surveying operation and, secondarily, the identity of the person operating as well as the identity of the equipment on which the preliminary surveying operation was carried out.

It will be understood in the following that the preliminary survey data is essentially used for guiding an autonomous machine that will traverse the rows of the plot in real-time to perform a geolocated cartographic record, called a fine survey here, which can subsequently be used multiple times by a machine of the same type or a machine of another type.

It should be noted that the preliminary surveying operation may be carried out on any type of digital device 9 with access to a cartographic database of satellite photos. The digital device in question may be a computer, for example, or a multifunction smart phone with internet connectivity.

### Path of the Machine Path and Actual Recording

On the basis of the initial survey data DARP1, the rows of the plot are traversed by an autonomous machine 2, introduced above. The autonomous machine 2 traverses all the rows, one after another, as will be seen later.

The row detection sensor 7 may take several forms; it may be a lidar sensor, for example. In a variant or in addition, it may also be an imaging device, such as a so-called “3D” camera, or a multispectral color camera, or any other optical means. As an alternative or in addition, ultrasound-technology sensors may also be used.

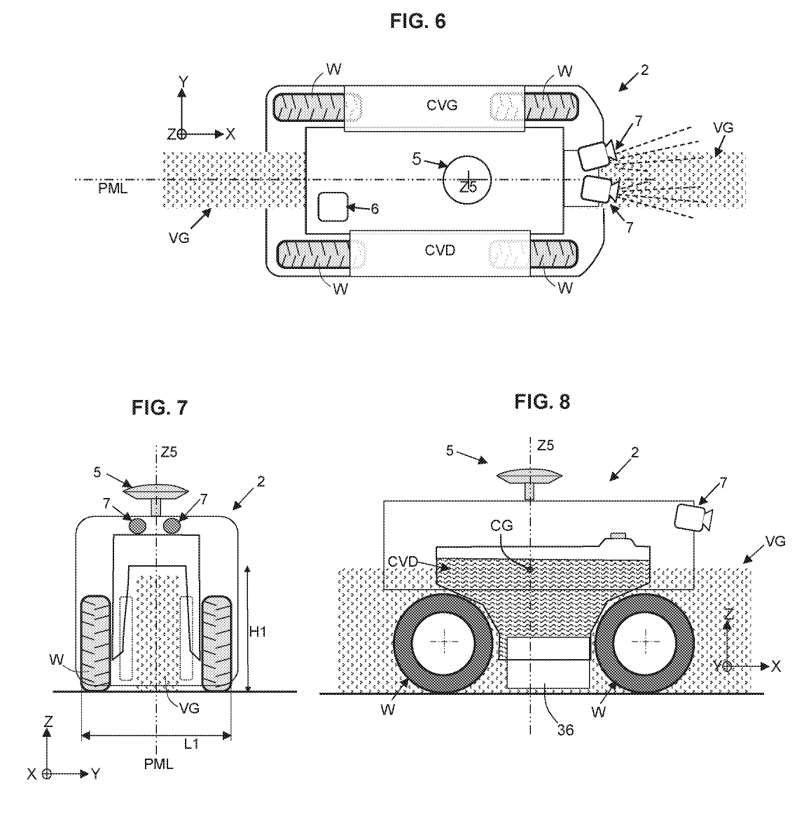

The row detection sensor may detect the row directly by the contours of its vegetation or by its footprint on the ground (plants, trunks, trellis stakes, etc.). In the case of a straddle tractor, detection sensors 7 of the lidar type are advantageously located overhanging the vegetation in a longitudinal median-plane area of the tractor, as illustrated in FIGS. 6-8, and thus have an ideal and unobstructed field of view of the vegetation row VG. The images or snapshots captured by the detection sensor can be analyzed separately or collectively by a control unit.

More precisely, a control unit, discussed below, is responsible for extracting the position of the vegetation plants from one or more snapshots captured, or, alternatively, a line corresponding to the centerline LC linking the different vegetation plants to each other.

According to one possible implementation, as the straddle machine advances relative to the vegetation row, the control unit treats a plurality of successive images in a logic similar to a known SLAM logic (Simultaneous Localization and Mapping). Determining the centerline LC is then more robust because it relies on a continuity of images.

Methods and systems for detecting a vegetation row are generally known per se, and therefore the function is not described further here.

The geolocation sensor 5 is configured to receive signals from one or more satellite constellations 50 comprising the GPS, Glonass and Galileo constellations. The term GNSS (Global Navigation Satellite System) is used to generically designate all these satellite positioning systems.

Preferably, the geolocation sensor 5 is mounted with an axis Z5 that lies in the longitudinal median plane PML of the machine 2.

The signals of the satellite positioning system can be used directly and without any other artifice.

However, in one interesting case, the signals received from the satellites 50 are used in combination with correction signals, called DRTK, received by a terrestrial wireless link (cellular phone type or specific radio link). The correction signals make it possible to compensate for certain inaccuracies caused by the path of the signals from the satellites 50 through the atmosphere of the Earth, as known per se and therefore not described in detail here. Producing the DRTK signals involves the presence of stationary beacons whose location is known with precision, whether a private beacon 55 (cf. FIG. 5) or a plurality of semi-public beacons distributed over a geographic area nearby.

For the record, the term RTK, now commonly used in the profession, comes from the English, “Real Time Kinematic”.

Using the coordinates present in the preliminary survey, the autonomous machine can enter the first row.

Advantageously, the autonomous machine traverses all the rows of the actual plot. According to one pertinent solution, the path of the autonomous machine 2 among the rows may correspond to the logic of FIG. 11; in this configuration, two consecutively traversed rows are not physically adjacent.

More precisely in the example of FIG. 11, the autonomous machine traverses the rows in the following order: T1, T4, T2, T5, T3, T6, T9, T7, T10, T8, T11, etc.; the preceding pattern can be repeated as many times as necessary. It is noted that the autonomous machine turns around at the end of each row; there is no “empty” return. In FIG. 11, the rows are traversed alternately from left to right, then from right to left.

It is verified that the number of rows of the actual plot corresponds to the number of rows present in the preliminary survey. A difference does not prevent the fine survey from being produced, but it may signal a problem in the preliminary survey.

With reference to FIG. 5, the autonomous machine 2 comprises a control system 3 which, in the illustrated example, is an electro-hydraulic control system. The control system 3 comprises a control unit 6 in particular, responsible for performing several functions, including the function of following rows and the surveying function that interest us here. The control unit 6 comprises an electronic computer and may optionally comprise an electro-hydraulic block, depending on the functional arrangement of the hydraulic circuits.

The case of a sprayer has been chosen as a non-limiting example and, in this case, the autonomous machine 2 comprises a left liquid tank CVG and a right liquid tank CVD, to feed the spraying nozzles. FIG. 8 also illustrates the presence of a ground-working tool in particular, referenced 36, which may be mounted on a lift system, as known per se and therefore not detailed here.

With reference to FIG. 5, the control unit 6 receives, as input, the satellite signals via the geolocation sensor 5, the signals from the row detection sensor(s) 7 and the correction signals of the geolocation system via a cellular communication interface 62. The control unit 6 may be able to communicate with a remote server 66 and/or with the computing device 9 that was used for the preliminary survey.

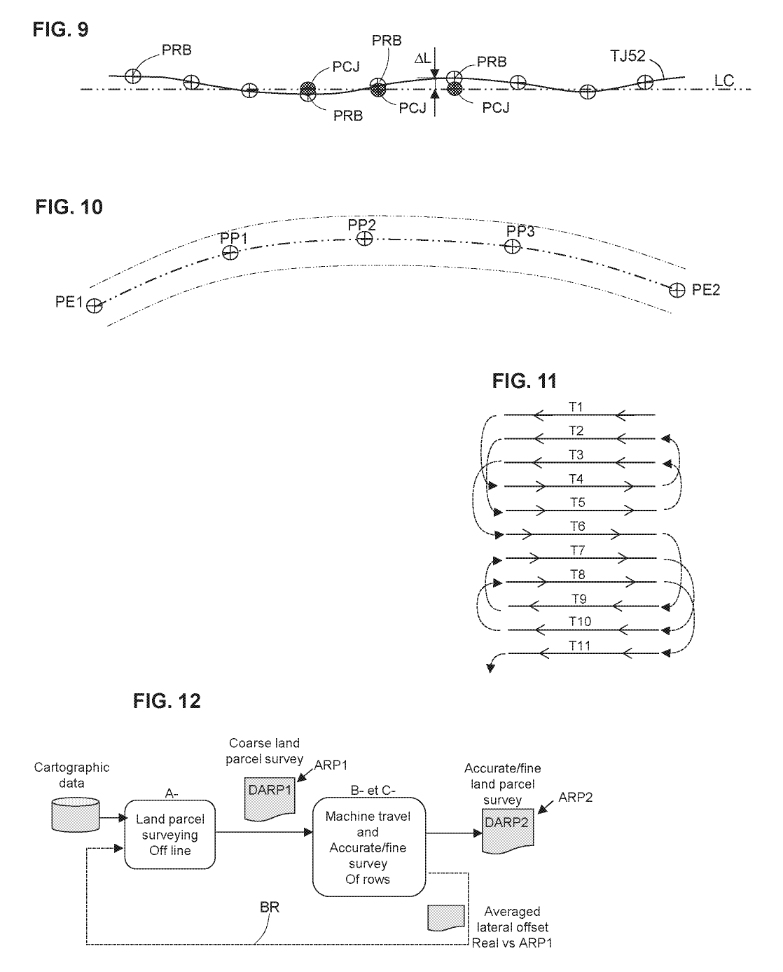

Turning to FIG. 9, it will be understood that the control unit 6 can determine a lateral offset ∆L of the current position of the machine PRB relative to a centerline LC of the row by using the information delivered by the row detection sensor(s) 7.

The row centerline LC is locally close to a straight line as represented in FIG. 9, but this does not exclude an overall curve of the row.

The row centerline LC can be determined by the machine 2 from the information delivered by the row detection sensor 7. The average position of the vegetation and/or of the shrub trunks, as detected by the row detection sensor(s) 7, makes it possible to determine where the row centerline LC lies at that point in the path of the row, relative to the structure of the machine, in particular relative to the longitudinal median plane PML.

Determining the row centerline LC relative to the structure of the machine firstly contributes to piloting the machine by a control loop when it is autonomously piloted. In addition, determining the row centerline LC relative to the structure of the machine further makes it possible to correct the geolocated position collected by means of the geolocation sensor, by projection, for example, as will be set out below.

The method uses an origin point of reference CG concerning the geometric frame X,Y,Z of the machine. Preferably, the origin point of reference CG lies in the longitudinal median plane PML. Preferably, the origin point of reference CG also lies on the axis Z5 that corresponds to the position of the geolocation sensor 5.

FIG. 9 represents successive positions, denoted PRB, of the geolocation sensor 5. It is observed that the trajectory of these successive points PRB does not coincide with the row centerline LC. This is due to the control loop of the autonomous piloting (or even manual piloting). What is of interest, for obtaining a precise survey of the vegetation rows, is the PRB position brought back to the row centerline.

The current projected geolocated position, denoted PCJ, is constructed by projection, by projecting the current geo-position of the geolocation sensor PRB onto the row centerline LC.

The projection in question is carried out either by taking the closest point on the row centerline LC from PRB point, or by projecting the current geo-position (PRB) perpendicularly to the local direction of the row centerline (LC) and toward the centerline (LC).

Thus, the control unit 6 constructs a current projected geolocated position, denoted PCJ, that lies on the row centerline LC, in order to deduce a so-called “refined” waypoint of the path of the row.

The precise location of the geolocation sensor of the autonomous machine is known at all times via the GNSS RTK. The autonomous machine navigates via its Lidar sensor (or another sensor) and its controller relative to the traversed row. The row detection sensor gives the lateral offset ∆L with the center of the row in real time. Thus, at each instant, one can subtract this offset ∆L from the GNSS RTK location to obtain the “true” center of the row.

From the refined waypoints, the second survey data DARP2 can be obtained. The above mechanism corresponds to step C- of the proposed method. The row following method using the row following sensors corresponds to step B- of the proposed method.

It is noted that the row following must compensate all the hazards of the ground and terrain over which the autonomous machine rolls. There may be one or more wet or even muddy areas in particular that may cause small wheel slips; there may also be clods of earth that may cause tire deformation and lateral movement. There may also be a small side slope. All this contributes to the impossibility of the autonomous machine perfectly following the theoretical trajectory line, which, in practice, produces the lateral offset ∆L discussed above. However, this lateral offset does not influence the accuracy of the points recorded, thanks to the projection mechanism onto the centerline LC described above. In practice, as illustrated in FIG. 9, the actual trajectory TJ52 of the autonomous machine, and, incidentally, of its geolocation sensor 5, does not coincide with an ideal trajectory that corresponds to the path of the neutral line, i.e. the row centerline LC. The lateral offset ∆L may exceed 10 cm or even 20 cm, and yet the promoted method will aim for and obtain accuracy in recording the path of the row to the centimeter, with an error of the order of one centimeter, well below the observed lateral offset ∆L.

To obtain concise fine survey data, a certain number of refined points PCJ collected, in particular the geo-positioning of the ends of rows (11a,11b,12a,12b) but also the waypoints, are assembled in a digital fine survey file, named ARP2.

Optionally, a graphical screen 4, with functions for displaying a certain amount of information in real time during the path of the autonomous machine, is provided in the autonomous machine.

As visible in FIG. 5, the control system 3 comprises actuators, used for forward motion and steering control of the machine, in particular solenoid valves 31, 32 and motors 33, 34; this configuration is given by way of simplified illustration but a person skilled in the art will be able to adapt it mutatis mutandis to the case of any machine.

The control system 3 also comprises one or more work tools 36, such as spraying or soil working. The ground work tools are lifted at the ends of the rows, to perform the turn, and are lowered again, to traverse the next row.

The preliminary survey data DARP1 can be received by wireless communication or alternatively can be loaded via a USB port with a physical connection to the control unit or one of its peripherals.

### Other Aspects and Characteristics

It should be noted that recording the geolocated positions by the autonomous machine during its path in the rows makes it possible to guarantee survey data in conformity with reality, whereas the preliminary survey may be affected by error, such as an old satellite photographic snapshot that no longer reflects the reality of the day. With the RTK option for the geolocation system, the accuracy of the fine survey data is of the order of one centimeter, which makes it possible to consider precision autonomous work on the rows of the plot.

Thus, the passage of the machine in all the rows guarantees second survey data DARP2 that is faithful to reality.

Once the fine survey data is established, it forms a file ARP2 that can be uploaded from the control unit of the autonomous machine to the server 66. The server 66 may be the server belonging to the agricultural or viticultural resort/farm, or may be a server at any cloud computing location (the “cloud”).

As illustrated in FIG. 10, the first and second survey data respectively comprise, for each row, a first position PE1 relative to a first row end, a second position PE2 relative to a second row end and optionally one or more waypoints PPi (i denotes an index here) at intermediate positions on the path of the row between the first end and the second end.

It is noted that there may be more waypoints PPi in the second survey data than in the preliminary survey, due to the need to provide a precise path of the row in order to be able to execute precision work on the vegetation.

In order to improve the preliminary surveying method, as already mentioned above, the control unit of the autonomous machine can record the difference between an actual position and the corresponding position given by the initial survey data. The control unit can record all these differences and average them to then deliver corrected information (akin to a general offset), referenced “mean real difference vs ARP1” in FIG. 12 (feedback loop BR).

According to an additional optional function, provision is made to take into account any lateral tilt of the machine, such as due to a side slope of the terrain. This information can be captured by an inclinometer, for example. The distance separating the geolocation sensor from ground level is multiplied by the sine of the tilt angle, which makes it possible to obtain an auxiliary lateral offset generated by the lateral tilt of the machine. This auxiliary lateral offset is added to or subtracted from the lateral offset ∆L discussed above, depending on the direction of tilt.

Ultimately, using the solution promoted here, a fine survey of the plot can be obtained more quickly and effectively than the solution known in the art with “manual” recording of the end of the rows. This makes it possible to implement more frequent updates in particular.

It will also be noted that the invention is not limited to the embodiments described above. It will in fact appear to the person skilled in the art that various modifications can be made to the embodiments described above, in light of the teaching that has just been disclosed to them.

In the detailed presentation of the invention given above, the terms used are not to be interpreted as limiting the invention to the embodiment set out in the present description, but are to be interpreted as including all equivalents that the person skilled in the art will anticipate by applying their general knowledge to implementing the teaching that has just been disclosed to them.

1. A method for producing a fine survey of a plot planted with a plurality of rows of vegetation, the method comprising:
A- a step of acquiring a preliminary survey (ARP1) from a digital device, comprising designating map points from cartographic data, and deducing initial survey data, directly or indirectly, for guidance purposes, the initial survey data comprising, for each row, a first position relative to a first end of a row, and a second position relative to a second end of a row,
B- a travel step, wherein, on the basis of the initial survey data, all the rows of the plot are traversed by an autonomous machine, preferably a straddle machine, equipped with a geolocation sensor forming part of a geolocation system that is accurate to the centimeter, with at least one row detection sensor, making it possible to determine an actual location of a row centerline relative to the machine, the geolocation sensor being preferably arranged on a longitudinal median plane of the autonomous machine, the travel step comprising, iteratively:
recording a current geo-position of the geolocation sensor and simultaneously determining a position of the centerline relative to the machine and relative to its geolocation sensor,
determining a current projected geolocated position on the centerline of the row,
in order to deduce refined and geolocated waypoints of the path of the row,
C- determining, from the refined waypoints, a set of new survey points to output second survey data forming a fine survey (ARP2) of the plot for precision work purposes,
the second survey data comprising, for each row, at least a first refined position of the first end of a row and a second refined position of the second end of a row.

2. The method according to claim 1, wherein the first and second survey data optionally comprise one or more waypoints at intermediate positions on the path of the row between the first end and the second end.

3. The method according to claim 1, wherein the first and second survey data comprise a delimitation of a work area that encompasses the plurality of rows and defines an external boundary of movement for the autonomous machine.

4. The method according to claim 3, wherein, during the travel step by the autonomous machine, one or more restrictions and/or modifications of the work area delimiting an external boundary of movement for the autonomous machine are defined, as applicable, in response to detection of an obstacle, for example.

5. The method according to claim 1, further comprising, for each survey point of the preliminary survey (ARP1), a comparison of the position acquired in real time relative to an estimated position obtained from the initial survey data.

6. The method according to claim 1, wherein two consecutively traversed rows are not physically adjacent during the travel step by the autonomous machine.

7. A system for producing a fine survey of a plot planted with a plurality of vegetation rows, comprising:a digital device for access to a cartographic database, in particular satellite photos, including a computer or a multifunction smart phone, for example, with a preliminary survey (ARP1) being able to be carried out offline from said digital device,an autonomous machine, preferably a straddle machine, equipped with a geolocation sensor forming part of a geolocation system with accuracy to the centimeter, and with at least one row detection sensor,the autonomous machine comprising at least one control unit configured to:acquire first guidance data resulting from a prior step of acquiring a preliminary survey (ARP1) from the digital device for access to a cartographic database, with the initial survey data comprising, for each row, a first position relative to a first end of a row, a second position relative to a second end of a row,collect second survey data, by traversing all the rows of the plot, resulting from determining a row centerline from the row detection sensor(s), and from simultaneously determining the current geo-position of the geolocation sensor of the machine,the control unit being configured to establish the second survey data that forms a fine survey, the second survey data comprising at least a first refined position of the first end of a row and a second refined position of the second end of a row, for each row.

8. The system according to claim 7, wherein the autonomous machine is a self-propelled straddle machine, and has a longitudinal median plane and the geolocation sensor (5) is located in the longitudinal median plane of the machine.

9. The system according to claim 7, wherein the at least one row detection sensor comprises a Lidar sensor.

10. The system according to claim 7, using an improved accuracy geolocation system using coordinate corrections known as DRTK.
